(19) United States
(12) Patent Application Publication
(10) Pub. No.: US 2006/0228685 A1
(43) Pub. Date: Oct. 12, 2006

(54) Audio speakers devise for delivering the sound of music, learning material or audio - recorded voice of parent(s) to unborn child through a pregnant woman's stomach

(76) Inventor: Vladimir Opra, Irving, TX (US)

Correspondence Address: VLADIMIR OPRA, 1219 MEADOW CREEK DR # A, IRVING, TX, 75038, US

(21) Appl. No.: 11/104,203

(22) Filed: Apr. 12, 2005

(51) Int. Cl. G09B 5/00; G09B 5/04

(52) U.S. Cl. 434/307 R; 434/319

(57) ABSTRACT

The technology/invention or audio-speakers devise for delivering the sound of music, learning material or audio-recorded voice to unborn child through a pregnant woman's stomach

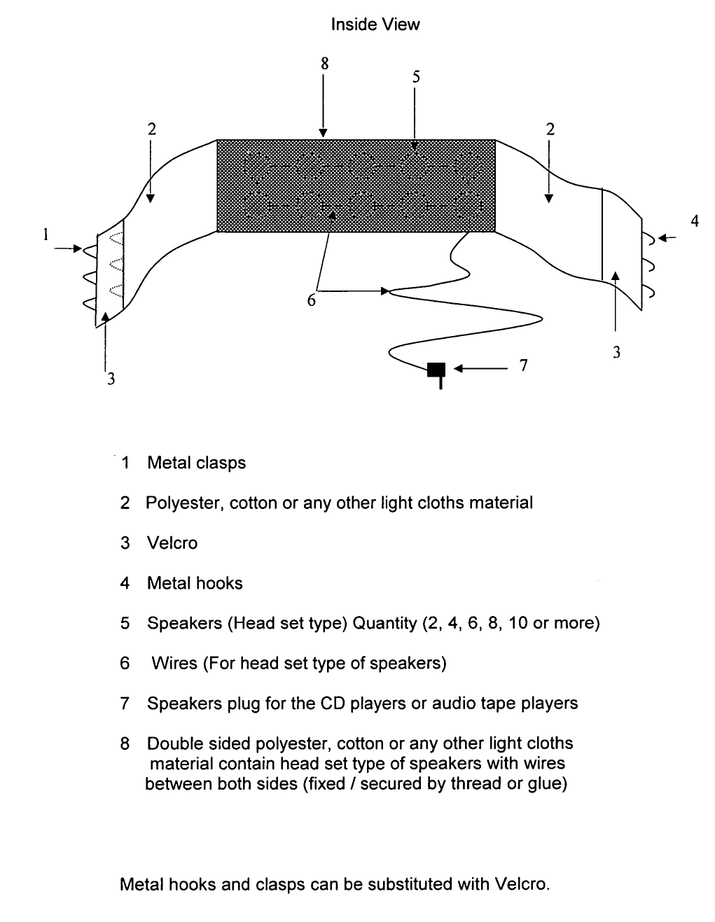

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of Utility and/or any new and useful improvement and more specifically to a technology or audio speakers devise for delivering the sound of music, learning material or recorded voice to unborn child through a pregnant woman's stomach.

According to scientist research for unborn human life movement, learning and hearing patterns start developing on 11th week after conception.

Additional sources (Essentials of Human Embryology William J. Larsen, Ph.D. Churchill Livingstone (New York), 1998. The Developing Human, 6th Edition Clinically Oriented Embryology Keith L. Moore, Ph.D., FIAC, FRSM T. V. N. Persaud, M.D., Ph.D., D.Sc., FRCPath W.B. Saunders Company (Philadelphia), 1998. The Developing Human, 4th Edition Clinically Oriented Embryolgy Keith L. Moore, M.Sc., Ph.D, F.I.A.C. W.B. Saunders Company (Philadelphia) 1988)

Not a same or similar devise or technology but the similar idea by the name “Baby Plus” Prenatal Education System (Inventor unknown) has been invented over 17 years ago.

According to “Pregnancy” Magazine Vol. 5 December 2004

Parents who have been using “Baby Plus” Prenatal Education System have reported

1. Improved school readiness and intellectual abilities

2. Longer attention spans

3. Earlier developmental milestones

4. Increased ability to self-soothe

5. Better sleeping patterns beginning in the early infancy

6. Infants nurse better

7. Babies are more alert and relaxed as newborns

For more information go to www.babyplus.com

| | |
|---|---|
| Prior technology | “Baby Plus” Good sound delivery |
| | machine is safe, scientifically proven |
| | through 18 years of research, and the |
| | benefits are remarkable. Over 60,000 |
| | children worldwide have already benefited. |
| | “Baby Plus” does not have abilities |
| | to deliver music or songs. |
| | “Baby Plus” does not have ability |
| | to deliver sound or Parent (s) voice. |
| | “Baby Plus” is not suitable while |
| | moving or extra sizing. |
| | “Baby Plus” Retail Price is $139.95 |
| Vladimir's Opra current | Have the abilities to deliver music or |
| technology/devise | songs. |
| | Have the ability to deliver sound of |
| | audio - recorded parent (s) voice. |
| | Suitable while moving or extra - sizing |
| | Retail price from $ 19.95 to $ 99.95 |

Light and comfortable adjustable stomach belt can be warred or placed on stomach area while walking, driving or performing any other physical extra-sizing by future mother as well as allowing her to place audio devise on the stomach area while watching TV or laying on the bed without clipping it or securing it from falling by using metal clasps and hooks or Velcro

### BRIEF SUMMARY OF THE INVENTION

The primary object of the invention is to help unborn child to recognize and memorize sounds music or his/her parent(s) audio-recorded voice.

Another object of the invention is to create early positive relationship between unborn children and parent(s) through recognition their audio-recorded voice, favorite's songs and music.

Another object of the invention is to help start learning and memorizing ABC & 123 on the early stages of unborn child's life.

| | |
|---|---|
| Also | *Babies are born more relaxed with their eyes and hands open |
| | *Infants sleep better and they cry little if at all. |
| | *Early parental voice recognition and stronger family bonding |
| | *Longer attention spans and accelerated developmental skills. |
| | *Advanced language, musical, and creative abilities |
| | *Enhanced curiosity and the ability to gather and process |
| | information very quickly. |
| | *Improved stress management and the ability to self-soothe |
| | *Expanded cognitive powers and testing has shown higher than |
| | average IQs |

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a invention/technology/devise for delivering the sound of music, learning material or audio-recorded voice of parent(s) to unborn child through a pregnant woman's stomach

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

A1 Audio speakers devise/invention for delivering the sound of music, learning material or audio-recorded voice of parent(s) to unborn child through a pregnant woman's stomach

A2 Light and comfortable adjustable stomach belt for the pregnant women with audio speakers kit.

A3 Audio speakers devise/invention designed to improve school readiness and intellectual abilities

A4 Audio speakers devise/invention designed to improve longer attention spans

A5 Audio speakers devise/invention designed to improve earlier developmental milestones

A6 Audio speakers devise/invention designed to improve and increase ability to self-soothe

A7 Audio speakers devise/invention designed to improve better sleeping patterns beginning in the early infancy

A8 Audio speakers devise/invention designed to improve infants nursing

### Qualities && Benefits

To help an unborn child recognize sound of music or his/her parent(s) voice by using audio or stereo device such as a CD, tape player or an other audio device as a supplement to development.

To create early positive relationship between the unborn child and his/her parent(s).

To provide a better learning experience using the alphabet and other educational tools within the early stages of the unborn child's memory

Light and comfortable and easy to wear

Improved school readiness and intellectual abilities

Longer attention spans

Earlier developmental milestones

Increased ability to self-soothe

Better sleeping patterns beginning in the early infancy

Infants nurse better

Babies are more alert and relaxed as newborns

Easily adjustable to obtain a perfect fit.

Product can be manufactured to different sizes such as Small, Medium, Large, Extra large etc.

Product can be worn over, above the clothes, or under the clothes.

Very thinned shaped and is almost invisible when worn under clothes.

Easy and inexpensive to manufacture

Affordable for the average income person or family

### Primary Elements

Musical and learning mono, stereo sound Kit for unborn child

Sound waves that carries into the mother's stomach to help the unborn child recognize and remember music and learning lessons as well as listen to their parent (s) recorded voices.

To create early positive relationship between child and parent(s)

To help create positive and a calm atmosphere for future mother and child,

### Secondary Elements

Head set size and type speakers

Polyester

Metal clasps

Metal hooks

Wires for the speakers

Speaker plug for the CD player outlet

Sewn in thread to hold the speakers in place

### Substitute Elements

Speakers

Cotton or other light cloth material

Velcro

Speakers plug for tape player outlet

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims

What claimed is:

1 Audio speakers devise/invention/technology for delivering the sound of music, learning material or audio-recorded voice of parent(s) to unborn child through a pregnant woman's stomach

2 Light and comfortable adjustable stomach belt for the pregnant women with audio speakers kit.

3 Audio speakers devise/invention/technology designed to improve school readiness and intellectual abilities

4 Audio speakers devise/invention/technology designed to improve longer attention spans

5 Audio speakers devise/invention/technology designed to improve earlier developmental milestones

6 Audio speakers devise/invention/technology designed to improve and increase ability to self-soothe

7 Audio speakers devise/invention/technology designed to improve better sleeping patterns beginning in the early infancy

8 Audio speakers devise/invention/technology designed to improve infants nursing
